(19) United States
(12) Patent Application Publication
(10) Pub. No.: US 2019/0369735 A1
(43) Pub. Date: Dec. 5, 2019

(54) METHOD AND SYSTEM FOR INPUTTING CONTENT

(71) Applicant: ALIBABA GROUP HOLDING LIMITED, George Town (KY)

(72) Inventors: Didi YAO, Hangzhou (CN); Congyu HUANG, Hangzhou (CN)

(21) Appl. No.: 16/542,162

(22) Filed: Aug. 15, 2019

Related U.S. Application Data
(63) Continuation of application No. PCT/CN2018/075236, filed on Feb. 5, 2018.

(30) Foreign Application Priority Data
Feb. 17, 2017 (CN) 201710085422.7

(51) Int. Cl. G06F 3/01; G06F 3/033; G06F 3/16

(52) U.S. Cl. CPC G06F 3/016; G06F 3/167; G06F 3/033

(57) ABSTRACT

Embodiments of the disclosure provide methods and systems for inputting content. The method can include: determining location information of a virtual surface in a three-dimensional space; obtaining location information of an input object in the three-dimensional space; determining, according to the location information of the input object and the location information of the virtual surface, whether the input object is in contact with the virtual surface; determining a trajectory of the input object when the input object is determined to be in contact with the virtual surface; and determining input content according to the determined trajectory.

### CROSS REFERENCE TO RELATED APPLICATION

The disclosure claims the benefits of priority to International application number PCT/CN2018/075236, and Chinese application number 201710085422.7, filed Feb. 17, 2017, both of which are incorporated herein by reference in their entireties.

### BACKGROUND

Virtual reality technologies are dedicated to integrating the virtual world with the real world, making users feel as real in the virtual world as they are in the real world. These technologies can create virtual worlds and can use computers to generate real-time and dynamic three-dimensional realistic images for integration of the virtual world and the real world. The essence of virtual reality technologies is a new revolution in human-computer interaction, and an input mode for the virtual reality technologies is the “last mile” of the human-computer interaction. For the input mode in virtual reality technologies, the best way is to make the input of the user in the virtual world to feel as real as the input in the real world. Therefore, the input mode of the virtual reality technologies is particularly important, and improvements are needed to the conventional input modes.

### SUMMARY OF THE DISCLOSURE

In view of the above, the present invention provides an input method and apparatus, a device, a system, and a computer storage medium, for providing an input mode applicable to virtual reality technologies.

Embodiments of the disclosure provide an input method. The method can include: determining location information of a virtual surface in a three-dimensional space; obtaining location information of an input object in the three-dimensional space; determining, according to the location information of the input object and the location information of the virtual surface, whether the input object is in contact with the virtual surface; determining a trajectory of the input object when the input object is determined to be in contact with the virtual surface; and determining input content according to the determined trajectory.

Embodiments of the disclosure also provide a computer system for inputting content. The system can include: a memory storing a set of instructions; and at least one processor configured to execute the set of instructions to cause the computer system to perform: determining location information of a virtual surface in a three-dimensional space; obtaining location information of an input object in the three-dimensional space; determining, according to the location information of the input object and the location information of the virtual surface, whether the input object is in contact with the virtual surface; determining a trajectory of the input object when the input object is determined to be in contact with the virtual surface; and determining input content according to the determined trajectory.

Embodiments of the disclosure further provide a non-transitory computer readable medium that stores a set of instructions that is executable by at least one processor of a computer system to cause the computer system to perform an input method. The method can include: determining location information of a virtual surface in a three-dimensional space; obtaining location information of an input object in the three-dimensional space; determining, according to the location information of the input object and the location information of the virtual surface, whether the input object is in contact with the virtual surface; determining a trajectory of the input object when the input object is determined to be in contact with the virtual surface; and determining input content according to the determined trajectory.

It can be seen from the technical solutions above that the present invention determines and records the location information of the virtual surface in the three-dimensional space, detects, according to the location information of the input object and the location information of the virtual surface, whether the input object is in contact with the virtual surface, and determines the input content according to the recorded trajectory generated in the process when the input object is in contact with the virtual surface. The present invention realizes information input in a three-dimensional space and is applicable to virtual reality technologies, so that the input experience of users in virtual reality is like that in a real space.

### BRIEF DESCRIPTION OF THE DRAWINGS

FIG. 1 is a schematic diagram of an exemplary system, according to embodiments of the disclosure.

FIG. 2 is a schematic diagram of an exemplary application scenario, according to embodiments of the disclosure.

FIG. 3 is a flowchart of an exemplary input method, according to embodiments of the disclosure.

FIG. 4A is a schematic diagram of determining whether an input object is in contact with a contact surface, according to embodiments of the disclosure.

FIG. 4B is a schematic diagram of a contact feedback, according to embodiments of the disclosure.

FIG. 5 is a flowchart of a character input method, according to embodiments of the disclosure.

FIG. 6A is a diagram of an exemplary character input, according to embodiments of the disclosure.

FIG. 6B is a diagram of another exemplary character input, according to embodiments of the disclosure.

FIG. 7 is a block diagram of an exemplary apparatus for a virtual reality input method, according to embodiments of the disclosure.

FIG. 8 is a block diagram of an exemplary computer system for a virtual reality input method, according to embodiments of the disclosure.

### DETAILED DESCRIPTION

To make the objectives, technical solutions and advantages of the disclosure clearer, the embodiments of the present disclosure will be described in detail below with reference to the accompanying drawings and specific embodiments.

The terms used in embodiments of the disclosure are merely intended to describe particular embodiments and are not intended to limit the embodiments of present disclosure. The singular forms “a” and “the” used in the embodiments and the appended claims of the disclosure are also intended to include plural forms, unless other meanings are clearly indicated in the context.

It should be understood that the term “and/or” as used herein is merely an association describing associated objects, and indicates that there may be three relationships, for example, A and/or B, which may indicate three cases, that is, A exists separately, A and B exist simultaneously, and B exists separately. In addition, the character “/” herein generally indicates that the contextual objects are in an “or” relationship.

Depending on the context, the word “if” as used herein may be interpreted as “at the time of” or “when” or “in response to determination” or “in response to detection.” Similarly, depending on the context, the phrase “if determined” or “if detected (conditions or events stated)” can be interpreted as “when determined” or “in response to determination” or “when detected (conditions or events stated)” or “in response to detection (conditions or events stated).”

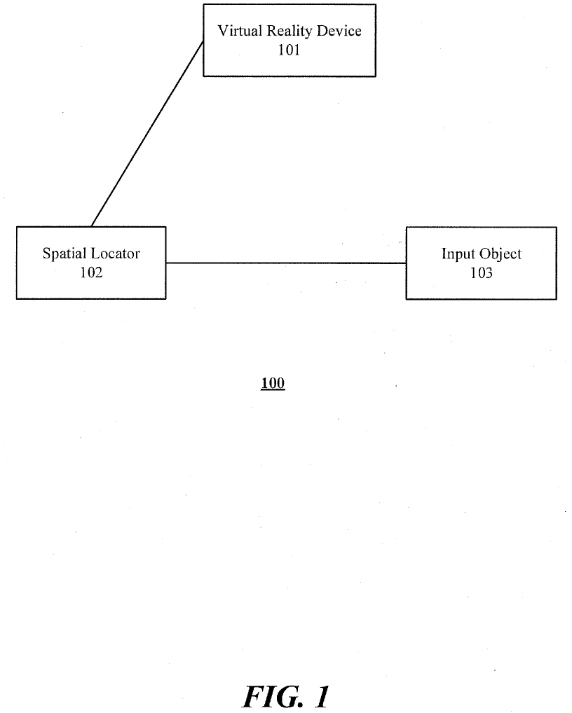

FIG. 1 is a schematic diagram of an exemplary system 100, according to embodiments of the disclosure. System 100 can includes a virtual reality device 101, a spatial locator 102, and an input object 103. Input object 103 can be held by the user for information input and can be a device in a form of a brush, one or more gloves, or the like. In some embodiments, the input object can be a user's finger.

Spatial locator 102 can include a sensor for determining a location of an object (e.g., input object 103) in a three-dimensional space. In some embodiments, spatial locator 102 can perform low-frequency magnetic field spatial positioning, ultrasonic spatial positioning, or laser spatial positioning to determine the location of the object.

For example, to perform the low-frequency magnetic field spatial positioning, the sensor of spatial locator 102 can be a low-frequency magnetic field sensor. A magnetic field transmitter in the sensor can generate a low-frequency magnetic field in the three-dimensional space, determine a location of a receiver with respect to the transmitter, and transmit the location to a host. The host can be a computer or a mobile device, which is a part of virtual reality device 101. In embodiments of the disclosure, the receiver can be disposed on input object 103. In other words, spatial locator 102 can determine the location of input object 103 in the three-dimensional space and provide the location to virtual reality device 101.

Also for example, to perform the laser spatial positioning, a plurality of laser-emitting devices can be installed in a three-dimensional space to emit laser beams scanning in both horizontal and vertical directions. A plurality of laser-sensing receivers can be disposed on the object, and the three-dimensional coordinates of the object can be obtained by determining an angular difference between two beams reaching the object. The three-dimensional coordinates of the object also change as the object moves, so as to obtain changed location information. This principle can also be used to locate the input object, which allows positioning of any input object without additionally installing an apparatus such as a receiver on the input object.

Virtual reality device 101 is a general term of devices capable of providing a virtual reality effect to a user or a receiving device. In general, virtual reality device 101 can include: a three-dimensional environment acquisition unit, a display unit, a sound unit, and an interaction unit.

The three-dimensional environment acquisition unit can acquire three-dimensional data of an object in a physical space (i.e., the real world) and performs re-creation in a virtual reality environment. The three-dimensional environment acquisition unit can be, for example, a 3D printing device.

The display device can display virtual reality images. The display device can include virtual reality glasses, a virtual reality helmet, an augmented reality device, a hybrid reality device, and the like.

The sound device can simulate an acoustic environment of the physical space and provide sound output to a user or a receiving device in a virtual environment. The sound device can be, for example, a three-dimensional surround acoustic device.

The interaction device can collect behaviors (e.g., an interaction or a movement) of the user or the receiving device in the virtual environment, and use the behaviors as a data input to generate feedback and changes to the virtual reality's environment parameters, images, acoustics, time, and the like. The interaction device can include a location tracking device, data gloves, a 3D mouse (or an indicator), a motion capture device, an eye tracker, a force feedback device, or the like.

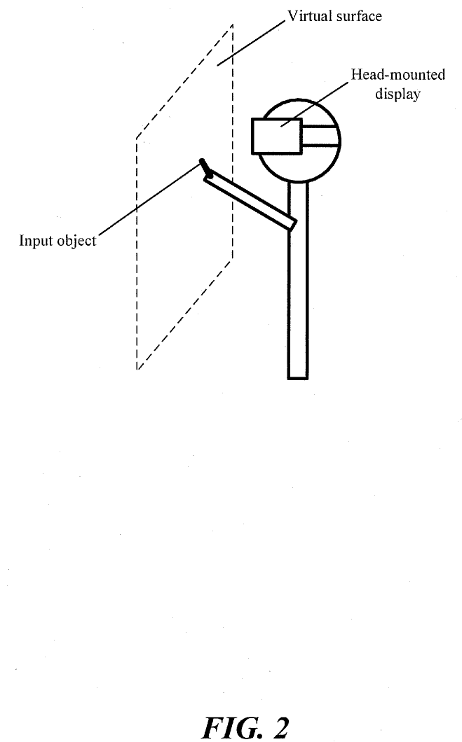

FIG. 2 is a schematic diagram of an exemplary application scenario, according to embodiments of the disclosure. As shown in FIG. 2, a user wears a virtual reality device (e.g., a head-mounted display), a virtual surface may be “generated” in the three-dimensional space when the user triggers an input function, and the user may hold the input object to operate on a virtual surface to perform information input. The virtual surface can be a reference location for the user input, and the virtual surface can be a virtual plane or a virtual curved surface. To improve the input experience of the user, the virtual surface can be presented in a certain pattern. For example, the virtual surface is presented as a blackboard, a blank sheet of paper, or the like. In this way, the user's input on the virtual surface is like writing on a blackboard or blank sheet of paper in the real world. The method capable of realizing the foregoing scenario will be described in detail below with reference to the embodiments.

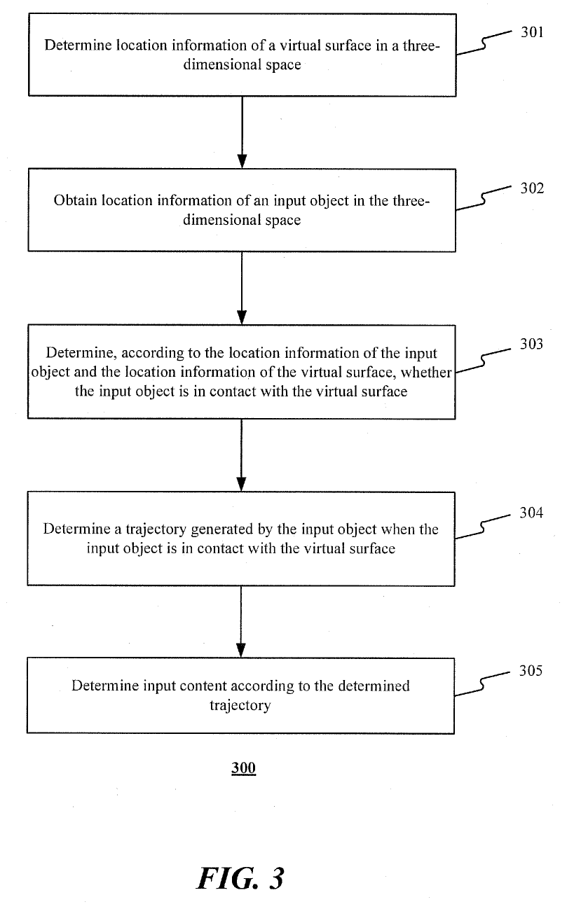

FIG. 3 is a flowchart of an exemplary input method 300, according to embodiments of the disclosure. As shown in FIG. 3, input method 300 can include the following steps.

In step 301, location information of a virtual surface in a three-dimensional space can be determined and recorded. This step can be executed when the user triggers the input function. For example, step 301 can be triggered when the user is required to enter a user name and a user password during user login or when chat content is inputted through an instant messaging application.

In this step, a virtual plane can be determined as the location of the virtual surface within the three-dimensional space touched by the user of the virtual reality device, and the user can input information by writing on the virtual surface. The virtual surface can be a reference location for the user input. The virtual surface can be a plane or a curved surface.

The location of the virtual surface may be determined by using a location of the virtual reality device as a reference location or may be determined by using a location of a computer or a mobile device to which the virtual reality device is connected as the reference location. In some embodiments, because the trajectory of the input object held by the user on the virtual surface can be detected by the location information of the spatial locator attached to the input object, the location of the virtual surface can be within a detection range of the spatial locator.

To allow the user to have a better “sense of distance” on the virtual surface, the embodiments of the present disclosure can additionally adopt two ways to make the user perceive the existence of the virtual surface, so that the user knows where to input data. One way can involve presenting tactile feedback information when the user touches the virtual surface with the input object, which will be described in detail later. Another way can involve presenting the virtual surface in a preset pattern. For example, the virtual surface can be presented as a blackboard, a blank sheet of paper, and the like. Therefore, the user can have a sense of distance in the input process and know where the virtual surface is located. Meanwhile, the user can write as if the user were writing on a medium (such as a blackboard or a blank sheet of paper).

In step 302, location information of an input object in the three-dimensional space can be obtained. The user can input data with the input object. For example, the user can hold a brush to write on the virtual surface, which has a “blackboard” pattern. The spatial locator can determine the location information of the input object during a movement of the input object. Therefore, the location information of the input object in the three-dimensional space detected by the spatial locator in real time can be obtained from the spatial locator. And the location information can be a three-dimensional coordinate value.

In step 303, whether the input object is in contact with the virtual surface is determined based on the location information of the input object and the location information of the virtual surface. By comparing the location information of the input object with the location information of the virtual surface, whether the input object is in contact with the virtual surface can be determined according to a distance therebetween. In some embodiments, whether a distance between the location of the input object and the location of the virtual surface is within a preset range can be determined, and if yes, it can be determined that the input object is in contact with the virtual surface. For example, when the distance between the input object and the virtual surface is within the range of [−1 cm, 1 cm], the input object can be determined as being in contact with the virtual surface.

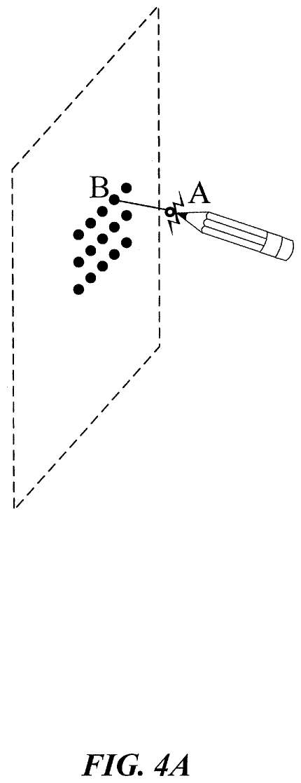

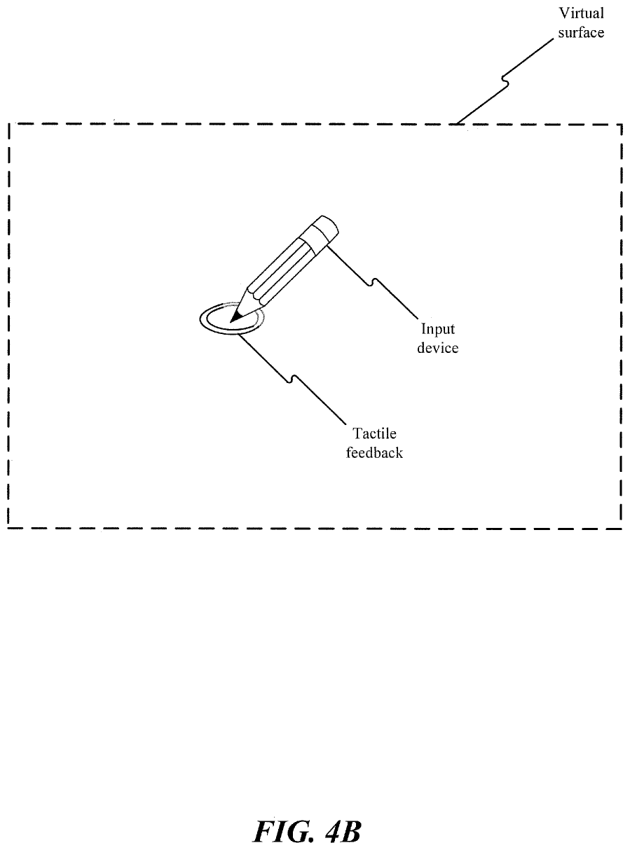

FIG. 4A is a schematic diagram of determining whether an input object is in contact with a contact surface, according to embodiments of the disclosure. As shown in FIG. 4A, when the distance between the location of the input object and the location of the virtual surface is determined, the virtual surface can be considered as being composed of a plurality of points on the surface, and the spatial locator detects the location information of the input object in real time, and transmits the location information to an apparatus that executes the method. The solid points in FIG. 4A presents exemplary points of the virtual surface, and the hollow point presents the location of the input object. The apparatus (e.g., system 100) can determine location A of the input object and location B of a point on the virtual surface closest to location A, and then determine whether the distance between A and B is within a preset range (e.g., [−1 cm, 1 cm]. If the distance between A and B is within a preset range, it can be determined that the input object is in contact with the virtual surface.

In addition to the embodiment of FIG. 4A, other ways for determining whether an input object is in contact with a contact surface can be applied. For example, the location of the input object can be projected to the virtual surface.

After touching the virtual surface, the user can create handwriting by keeping in contact with the virtual surface and moving. As mentioned above, to provide the user with a better sense of distance and facilitate the input, tactile feedback can be presented when the input object is in contact with the virtual surface.

In some embodiments, the tactile feedback can be visual feedback. For example, the tactile feedback can be presented by changing the color of the virtual surface. When the input object is not in contact with the virtual surface, the virtual surface is white. When the input object is in contact with the virtual surface, the virtual surface becomes gray to indicate that the input object is in contact with the virtual surface.

In some embodiments, the tactile feedback can be audio feedback. For example, the tactile feedback can be presented by playing a prompt tone indicating that the input object is in contact with the virtual surface. For example, when the input object is in contact with the virtual surface, preset music can be played, and when the input object leaves the virtual surface, the music can be paused.

In some embodiments, as another example of visual feedback, a contact point of the input object on the virtual surface is presented in a preset pattern. For example, when the input object is in contact with the virtual surface, a water-wave contact point is formed. When the input object gets closer to the virtual surface, the water wave can become larger. The water wave can simulate the pressure on the medium in the user's writing process, as shown in FIG. 4B. The pattern of the contact point is not limited by the present disclosure, and may be a simple black dot. When the input object is in contact with the virtual surface, a black dot is displayed at the contact location, and when the input object leaves the virtual surface, the black dot disappears.

In some embodiments, the tactile feedback can be a vibration feedback provided by the input object. It is appreciated that the input object can have a vibration unit to provide the vibration feedback. For example, the virtual reality device can determine whether the input object is in contact with the virtual surface at a very short time interval and send a trigger message to the input object when the input object is in contact with the virtual surface. The input object can provide the vibration feedback in response to the trigger message. When the input object leaves the virtual surface, the input object may not receive the trigger message and no vibration feedback is provided. Thus, during the writing on the virtual surface, the vibration feedback can be sensed by the user when the virtual surface is touched, so that the user can clearly perceive the contact state of the input object with the virtual surface.

The trigger message sent by the virtual reality device to the input object may be sent via a wireless communication (e.g., WiFi, Bluetooth, and Near Field Communication (NFC). The trigger message may also be sent via a wired communication.

Referring back to FIG. 3, in step 304, a trajectory generated by the input object when the input object is determined to be in contact with the virtual surface can be determined and recorded. Because the movement of the input object in the three-dimensional space is three-dimensional, the three-dimensional motion (a series of location points) can be converted to a two-dimensional movement on the virtual surface. The location information of the input object can be projected on the virtual surface to generate projection points when the input object is in contact with the virtual surface. The trajectory formed by the projection points can be determined and recorded, e.g., when the input object is separated from the virtual surface. The trajectory of this record can be seen as handwriting.

In step 305, input content is determined according to the determined trajectory. The user can input data in a manner of “drawing.” In the manner of “drawing,” a line consistent with the recorded trajectory can be displayed on-screen according to the recorded trajectory. After the on-screen display is completed, the recorded trajectory is cleared, and the current handwriting input is completed, detection is restarted, and the handwriting generated by contacting the input object with the virtual surface next time is recorded.

For example, the user wants to input a character in the manner of “drawing.” If the user inputs the trajectory of the letter “a” on the virtual surface, the letter “a” can be obtained by matching, and the letter “a” is directly displayed on-screen. It is also applicable to some numbers that can be completed in one stroke. For example, if the user inputs the number “2” on the virtual surface, the number “2” can be obtained by matching, and the number “2” can be directly on-screen displayed. After the on-screen display is completed, the recorded trajectory is cleared, and the current handwriting input is completed; detection is restarted, and the handwriting generated by contacting the input object with the virtual surface next time is recorded.

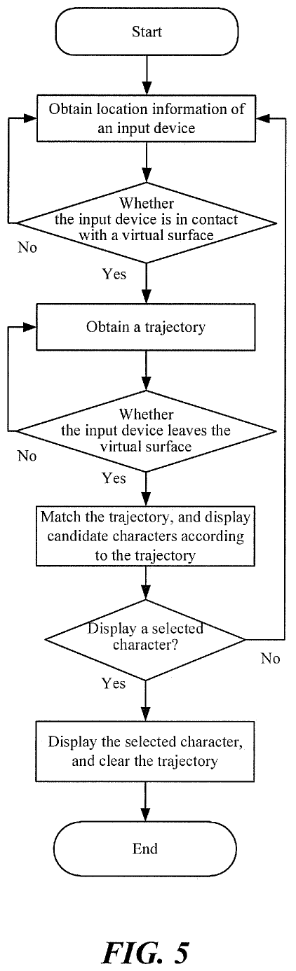

If the user wants to input an Asian character, the adopted input mode can be either spelling or stroking. For example, when the user wants to input a first Chinese character, the user can inputs spelling (e.g., pingyin) of the first Chinese character on the virtual surface, and therefore a trajectory of the spelling can be generated and recorded. The user can also stroke the first Chinese character on the virtual surface, and a trajectory of the stroking can be generated and recorded. Then, candidate characters corresponding to the recorded trajectory can be displayed according to the recorded trajectory. If the user does not select any candidate character, the recorded trajectory of the first Chinese character can be stored as a first trajectory. Then, system 100 can continue to detect and record a second trajectory of a second Chinese character input by the user. The first trajectory and the second trajectory can be combined to generate a recorded trajectory, and the system 100 can provide candidate characters corresponding to the recorded trajectory. If the user still does not select any candidate character and continues the input of a third Chinese character, a third trajectory corresponding the third Chinese character can be further detected and recorded, and combined with the recorded trajectory to update the recorded trajectory. Accordingly, one or more candidate characters corresponding to the recorded trajectory can be provided. The above process can continue until the user selects one of the candidate characters for on-screen display. After the on-screen display is completed, the recorded trajectory can be cleared, and the input of the next character can start. The input process of a character can be shown in FIG. 5.

In addition, the trajectory input by the user can be displayed on the virtual surface, and the trajectory displayed on the virtual surface can be cleared when the on-screen display is completed. The trajectory may be cleared manually by, e.g., a specific gesture. For example, by clicking the “Clear Trajectory” button on the virtual surface, the trajectory displayed on the virtual surface can be cleared.

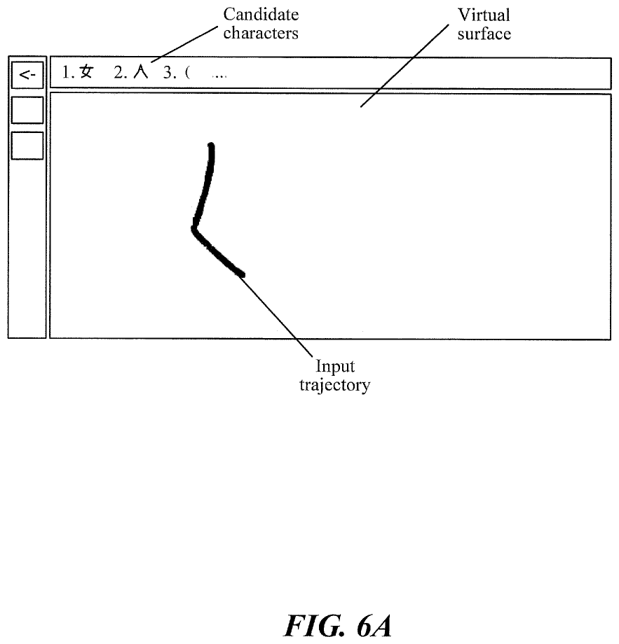

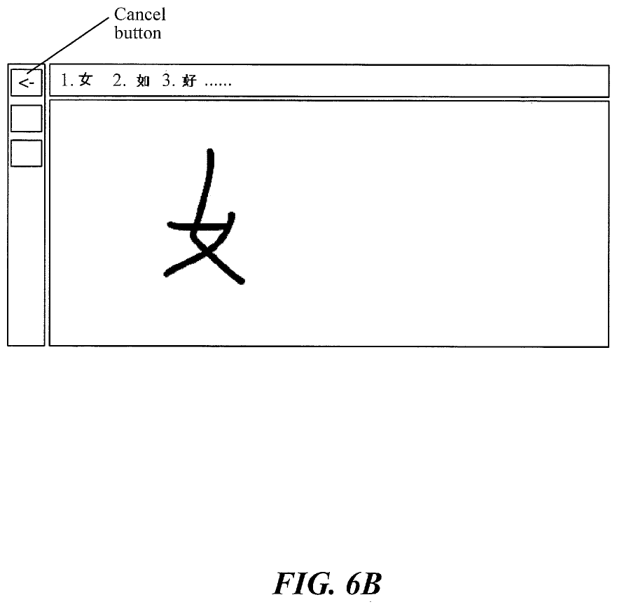

To facilitate understanding, an example is provided. It is assumed that the user inputs a handwriting “ [symbol] ” through an input object, records the trajectory, and then displays candidate characters matching the recorded trajectory according to the recorded trajectory, such as “ [symbol] ,” “ [symbol] ,” and “(,” as shown in FIG. 6A. If no character that the user wants to input exists in the candidate characters, the user continues inputting a handwriting “/,” and the trajectory is recorded, so that the recorded trajectory is composed of “ [symbol] ” and “/,” and candidate characters matching the recorded trajectory are displayed, such as “ [symbol] ,” “ [symbol] ,” and “X.” If there is no character that the user wants to input, the user continues inputting a handwriting “-,” so that the recorded trajectory is composed of “ [symbol] ,” “/” and “-,” and candidate characters matching the recorded trajectory are displayed, such as “ [symbol] ,” “ [symbol] ,” and “ [symbol] ,” as shown in FIG. 6B. Assuming that the character “ [symbol] ” that the user wants to input is already in the candidate characters in this case, the user can select the character “ [symbol] ” from the candidate characters for on-screen display. After the on-screen display is completed, the recorded trajectory and the trajectory displayed on the virtual surface are cleared. The user can start the input of the next character.

If the user wants to cancel an input trajectory in the process of inputting a character, a gesture to cancel the input can be performed. The recorded trajectory can be cleared when the user's gesture to cancel the input is captured. The user can re-enter the current character. For example, a “Cancel” button can be disposed on the virtual surface, as shown in FIG. 6B. If a click operation of the input object on the “Cancel” button is captured, the recorded trajectory can be cleared, and the corresponding trajectory displayed on the virtual surface can be cleared. Other gestures can also be used, such as quickly moving the input object to the left, quickly moving the input object up, etc., without touching the virtual surface.

It should be noted that the above methods described with reference to FIGS. 3, 4A, 4B, 5, 6A, and 6B can be executed by an input apparatus (e.g., system 100) including virtual reality device 101.

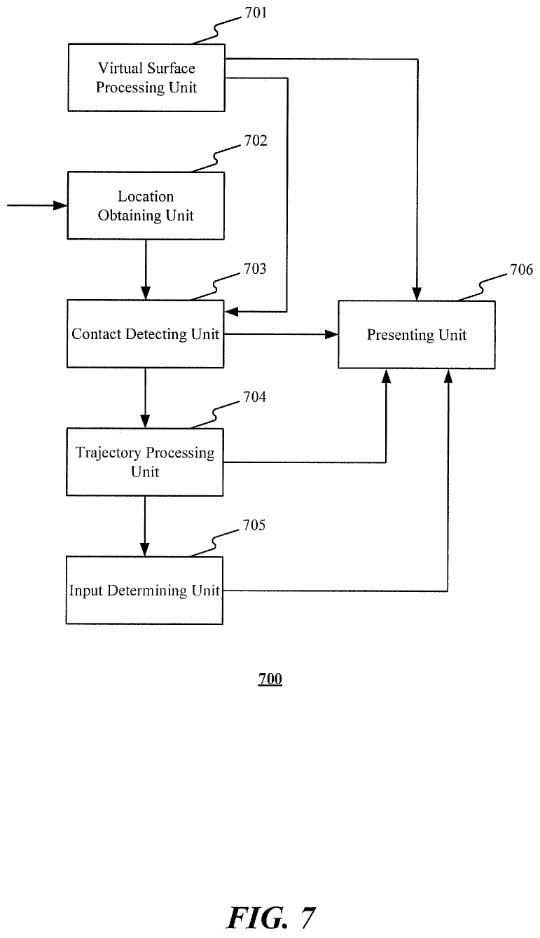

FIG. 7 is a block diagram of an exemplary apparatus 700 for a virtual reality input method, according to embodiments of the disclosure. As shown in FIG. 7, apparatus 700 can include a virtual surface processing unit 701, a location obtaining unit 702, a contact detecting unit 703, a trajectory processing unit 704, and an input determining unit 705. In some embodiments, apparatus 700 can further include a presenting unit 706.

Virtual surface processing unit 701 can determine location information of a virtual surface in a three-dimensional space. In the embodiment of the disclosure, a virtual plane can be determined as the location of the virtual surface within the three-dimensional space touched by the user of virtual reality device 101, and the user can input information by writing on the virtual surface. The virtual surface can include a reference location for the user input. In addition, to detect the trajectory of the input object held by the user on the virtual surface, the location information of the input object is detected by the spatial locator, and thus, the location of the virtual surface is within the detection range of the spatial locator.

Presenting unit 706 can present the virtual surface in a preset pattern. For example, presenting unit 706 can present the virtual surface as a blackboard, a blank sheet of paper, and the like. Therefore, the user can have a sense of distance in the input process and know where the virtual surface is located. Also, the user can write as if on a medium such as a blackboard or a blank sheet of paper, and the user experience is better.

Location obtaining unit 702 can obtain location information of an input object in the three-dimensional space. For example, the location information of the input object can be obtained by the spatial locator, and the location information can be a three-dimensional coordinate value.

Contact detecting unit 703 can detect, according to the location information of the input object and the location information of the virtual surface, whether the input object is in contact with the virtual surface. By comparing the location information of the input object with the location information of the virtual surface, it is possible to determine whether the input object is in contact with the virtual surface according to the distance therebetween. For example, whether a distance between the location of the input object and the location of the virtual surface is within a preset range can be determined. And if the distance is within a preset threshold, it can be determined that the input object is in contact with the virtual surface. For example, when the distance between the input object and the virtual surface is within the range of [−1 cm, 1 cm], it is considered that the input object is in contact with the virtual surface.

Trajectory processing unit 704 can determine a trajectory of the input object when the input object is determined to be in contact with the virtual surface.

Presenting unit 06 can also present the tactile feedback information when the input object is in contact with the virtual surface. The tactile feedback information can include at least one of: color of the virtual surface, a prompt tone indicating that the input object is in contact with the virtual surface, a contact point of the input object on the virtual surface, and a vibration feedback.

For example, the color of the virtual surface can be changed as the tactile feedback information. When the input object does not touch the virtual surface, the virtual surface can be white. When the input object is in contact with the virtual surface, the virtual surface can become gray to indicate that the input object is in contact with the virtual surface.

Also as an example, the prompt tone indicating that the input object is in contact with the virtual surface can be played as the tactile feedback information. When the input object is in contact with the virtual surface, the preset tone (e.g., a piece of music) can be played, and when the input object leaves the virtual surface, the preset tone can be paused.

Also as an example, the contact point of the input object on the virtual surface can be presented in a preset pattern as the tactile feedback information. For example, once the input object is in contact with the virtual surface, a water-wave contact point is formed. The closer the distance to the virtual surface is, the larger the water wave is, which likes simulating the pressure on the medium in the user's actual writing process, as shown in FIGS. 4A-4B. The pattern of the contact point is not limited by the present invention and may be a simple black dot. When the input object is in contact with the virtual surface, a black dot is displayed at the contact location, and when the input object leaves the virtual surface, the black dot disappears.

Also as an example, the vibration feedback can be provided by the input object as the tactile feedback information. In this case, the input object can have a message receiving ability and a vibration ability, so as to provide the vibration feedback.

Virtual reality device 101 can discriminate whether the input object is in contact with the virtual surface at a very short time interval and sends a trigger message to the input object when it is discriminated that the input object is in contact with the virtual surface. The input object provides vibration feedback after receiving the trigger message. When the input object leaves the virtual surface, the input object does not receive a trigger message, and no vibration feedback is provided. In this way, the user can have such an experience in the input process: during the writing on the virtual surface, the vibration feedback is sensed when the virtual surface is touched, so that the user can clearly perceive the contact state of the input object with the virtual surface.

The trigger message sent by the virtual reality device to the input object may be sent in a wireless manner, such as WiFi, Bluetooth, and NFC, or may be sent in a wired manner.

Since the motion of the input object in the three-dimensional space is three-dimensional, the three-dimensional motion (a series of location points) may be converted to a two-dimensional motion on the virtual surface. The trajectory processing unit 704 can obtain the projection of the location information of the input object on the virtual surface in the process when the input object is in contact with the virtual surface. When the input object is separated from the virtual surface, trajectory processing unit 704 can determine and record a trajectory formed by all projection points in the process when the input object is in contact with the virtual surface.

The input determining unit 705 is responsible for determining input content according to the recorded trajectory. Specifically, the input determining unit 705 can display on-screen, according to the recorded trajectory, a line consistent with the recorded trajectory, a character matching the recorded trajectory; one or more candidate characters matching the recorded trajectory, and the candidate character selected by the user. The candidate character is presented by presenting unit 706.

Furthermore, trajectory processing unit 704 clears the recorded trajectory upon completion of an on-screen display operation and starts the input of a next character. Or, the recorded trajectory is cleared after capturing the gesture of canceling the input, and the input processing of the current character is performed again.

In addition, presenting unit 706 can present on the virtual surface a trajectory generated in the process when the input object is in contact with the virtual surface and clear the trajectory presented on the virtual surface upon completion of an on-screen display operation.

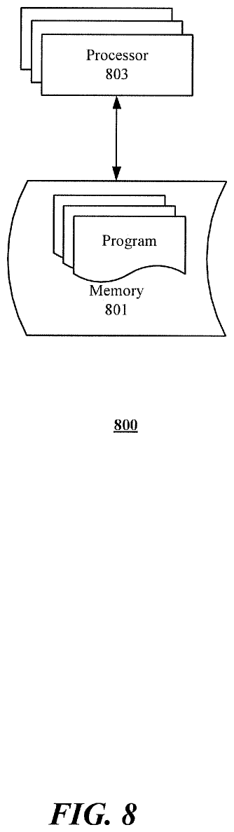

FIG. 8 is a block diagram of an exemplary computer system 800 for a virtual reality input method, according to embodiments of the disclosure. Computer system 800 can include a memory 801 and at least one processor 803. Memory 801 can include a set of instructions that is executable by at least one processor 803. At least one processor 803 can execute the set of instruction to cause the computer system 800 to perform the above-described methods.

In addition, functional units in various embodiments described above may be integrated into one processing unit, or each of the units may exist alone physically, or two or more units are integrated into one unit. The foregoing integrated unit may be implemented in the form of hardware or may be implemented in the form of a hardware plus software functional unit.

The foregoing integrated unit implemented in the form of a software functional unit can be stored in a computer readable storage medium. The foregoing software functional unit is stored in a storage medium, including several instructions for enabling a computer device (which may be a personal computer, a server, or a network device, etc.) or a processor to execute some steps of the method of each embodiment of the disclosure. The foregoing storage medium includes any medium that can store program codes, such as a USB flash drive, a removable hard disk, a Read-Only Memory (ROM), a Random Access Memory (RAM), a magnetic disk, or an optical disc.

The above are only preferred embodiments of the disclosure and are not intended to limit the scope of the present disclosure. Any modification, equivalent substitution, improvement, etc. made within the spirit and principle of the disclosure should be included in the protection scope of the disclosure.

1. A method for inputting content, comprising:
determining location information of a virtual surface in a three-dimensional space;
obtaining location information of an input object in the three-dimensional space;
determining, according to the location information of the input object and the location information of the virtual surface, whether the input object is in contact with the virtual surface;
determining a trajectory of the input object when the input object is determined to be in contact with the virtual surface; and
determining input content according to the determined trajectory.

2. The method according to claim 1, wherein obtaining the location information of the input object in the three-dimensional space comprises:
obtaining the location information of the input object by a spatial locator.

3. The method according to claim 1, wherein determining whether the input object is in contact with the virtual surface comprises:
determining whether a distance between the location of the input object and the location of the virtual surface is within a range; and
in response to the distance being within the range, determining that the input object is in contact with the virtual surface.

4. The method according to claim 1, further comprising:
in response to the determination that the input object is in contact with the virtual surface, providing tactile feedback.

5. The method according to claim 4, wherein providing tactile feedback comprises at least one of:
changing the color of the virtual surface;
playing a prompt tone indicating that the input object is in contact with the virtual surface;
presenting a contact point of the input object on the virtual surface in a preset pattern; or, providing a vibration feedback by the input object.

6. The method according to claim 1, wherein determining the trajectory of the input object when the input object is determined to be in contact with the virtual surface further comprises:
obtaining a projection of the location information of the input object on the virtual surface when the input object is determined to be in contact with the virtual surface; and
determining a projection trajectory generated based on the projection of the location information of the input object on the virtual surface, when the input object is no longer in contact with the virtual surface.

7. The method according to claim 1, wherein determining the input content according to the determined trajectory further comprises:
displaying the input content, wherein the input content comprises at least one of a line determined according to the trajectory and a character determined according to the trajectory, wherein the character is selected from candidate characters determined according to the trajectory.

8. The method according to claim 7, further comprising:
clearing the trajectory upon completion of displaying the input content; or
clearing the trajectory after capturing a gesture to cancel the trajectory.

9. The method according to claim 7, further comprising:
presenting on the virtual surface the trajectory generated in the process when the input object is determined to be in contact with the virtual surface, and clearing the trajectory presented on the virtual surface upon completion of the on-screen display operation.

10. A computer system for inputting content, comprising:
a memory storing a set of instructions; and
at least one processor configured to execute the set of instructions to cause the computer system to perform:
determining location information of a virtual surface in a three-dimensional space;
obtaining location information of an input object in the three-dimensional space;
determining, according to the location information of the input object and the location information of the virtual surface, whether the input object is in contact with the virtual surface;
determining a trajectory of the input object when the input object is determined to be in contact with the virtual surface; and
determining input content according to the determined trajectory.

11. The system according to claim 10, wherein obtaining the location information of the input object in the three-dimensional space comprises:
obtaining the location information of the input object by a spatial locator.

12-18. (canceled)

19. A non-transitory computer readable medium that stores a set of instructions that is executable by at least one processor of a computer system to cause the computer system to perform an input method, the method comprising:
determining location information of a virtual surface in a three-dimensional space;
obtaining location information of an input object in the three-dimensional space;
determining, according to the location information of the input object and the location information of the virtual surface, whether the input object is in contact with the virtual surface;
determining a trajectory of the input object when the input object is determined to be in contact with the virtual surface; and
determining input content according to the determined trajectory.

20. The non-transitory computer readable medium according to claim 19, wherein obtaining the location information of the input object in the three-dimensional space comprises:
obtaining the location information of the input object by a spatial locator.

21. The non-transitory computer readable medium according to claim 19, wherein determining whether the input object is determined to in contact with the virtual surface comprises:
determining whether a distance between the location of the input object and the location of the virtual surface is within a range; and
in response to the distance being within the range, determining that the input object is in contact with the virtual surface.

22. The non-transitory computer readable medium claim 19, wherein the set of instructions that is executable by the at least one processor of the computer system to cause the computer system to further perform:
in response to the determination that the input object is in contact with the virtual surface, providing tactile feedback.

23. The non-transitory computer readable medium according to claim 22, wherein providing tactile feedback comprises at least one of:
changing the color of the virtual surface;
playing a prompt tone indicating that the input object is in contact with the virtual surface;
presenting a contact point of the input object on the virtual surface in a preset pattern; or,
providing a vibration feedback by the input object.

24. The non-transitory computer readable medium claim 19, wherein determining the trajectory of the input object when the input object is determined to be in contact with the virtual surface further comprises:
obtaining a projection of the location information of the input object on the virtual surface when the input object is determined to be in contact with the virtual surface; and
determining a projection trajectory generated based on the projection of the location information of the input object on the virtual surface, when the input object is no longer in contact with the virtual surface.

25. The non-transitory computer readable medium according to claim 19, wherein determining the input content according to the determined trajectory further comprises:
displaying the input content, wherein the input content comprises at least one of a line determined according to the trajectory and a character determined according to the trajectory, wherein the character is selected from candidate characters determined according to the trajectory.

26. The non-transitory computer readable medium according to claim 25, wherein the set of instructions that is executable by the at least one processor of the computer system to cause the computer system to further perform:
clearing the trajectory upon completion of displaying the input content; or
clearing the trajectory after capturing a gesture to cancel the trajectory.

27. The non-transitory computer readable medium according to claim 26, wherein the set of instructions that is executable by the at least one processor of the computer system to cause the computer system to further perform:
presenting on the virtual surface the trajectory generated in the process when the input object is determined to be in contact with the virtual surface, and clearing the trajectory presented on the virtual surface upon completion of the on-screen display operation.
